(19) United States
(12) Patent Application Publication
(10) Pub. No.: US 2012/0290934 A1
(43) Pub. Date: Nov. 15, 2012

(54) METHOD OF RETRIEVING AND NAVIGATING INFORMATION USING A LOGICAL KEYWORD OR CODE

(76) Inventors: Lasell Anderson, Lake Worth, FL (US); Tanesha Ann-Marie Anderson, Lake Worth, FL (US)

(21) Appl. No.: 13/470,243

(22) Filed: May 11, 2012

Related U.S. Application Data
(60) Provisional application No. 61/484,789, filed on May 11, 2011.

(51) Int. Cl. G06F 3/048

(52) U.S. Cl. 715/732

(57) ABSTRACT

A method of retrieving and navigating information using logical keywords or codes where the method includes digitizing content; categorizing the digitized content using a keyword taxonomy; storing the categorized content on a storage device; providing access to the categorized content in at least one of a global, local, or personal context; and displaying the categorized content as a content slide show.

### CROSS-REFERENCE TO RELATED APPLICATIONS

This application claims the benefit of priority of U.S. provisional patent application No. 61/484,789, filed May 11, 2011, the contents of which are herein incorporated by reference.

### BACKGROUND OF THE INVENTION

The present invention relates to methods of retrieving and navigating information and more particularly, to methods of retrieving and navigating information using a logical keyword or code and using content frames for displaying and navigating the information.

### SUMMARY OF THE INVENTION

In one aspect of the present invention, a method for retrieving and navigating information using logical keywords or codes comprises categorizing digitized content using a keyword taxonomy; storing the categorized content on a storage device; providing access to the categorized content in at least one of a global, local or personal context; and displaying the categorized content as a content slide show.

In another aspect of the present invention, a method for retrieving and navigating information using logical keywords or codes comprises digitizing content; categorizing digitized content using a keyword taxonomy; storing the categorized content on a storage device; providing access to the categorized content in at least one of a global, local or personal context; displaying the categorized content as a content slide show; and using a file system to leverage and manage the stored categorized content by creating a self-indexing mechanism of organizing the content into individual folders.

These and other features, aspects and advantages of the present invention will become better understood with reference to the following drawings, description and claims.

### BRIEF DESCRIPTION OF THE DRAWINGS

FIG. 1 is a schematic view showing a method for content retrieval, delivery and navigation according to an exemplary embodiment of the present invention;

FIG. 2 is a schematic representation of content navigation and display of Frame A for content retrieved from the system of the present invention;

FIG. 3 is a schematic representation of content navigation and display of Frame B for content retrieved from the system of the present invention;

FIG. 4 is a schematic representation of frame content animated navigation according to an exemplary embodiment of the present invention;

FIG. 5 is a schematic representation of frame content multi-stream navigation according to an exemplary embodiment of the present invention;

FIG. 6 is a schematic representation of frame historical content navigation according to an exemplary embodiment of the present invention;

FIG. 7 is a schematic representation showing other frame functionality and behavior according to an exemplary embodiment of the present invention;

FIG. 8 is a schematic representation of a frame usage scenario as digital signage according to an exemplary embodiment of the present invention; and

FIG. 9 is a schematic representation of a single frame usage scenario as a screensaver according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method of retrieving and navigating information using logical keywords or codes, the method comprising digitizing content; categorizing the digitized content using a keyword taxonomy; storing the categorized content on a storage device; providing access to the categorized content in at least one of a global, local, or personal context; and displaying the categorized content as a content slide show.

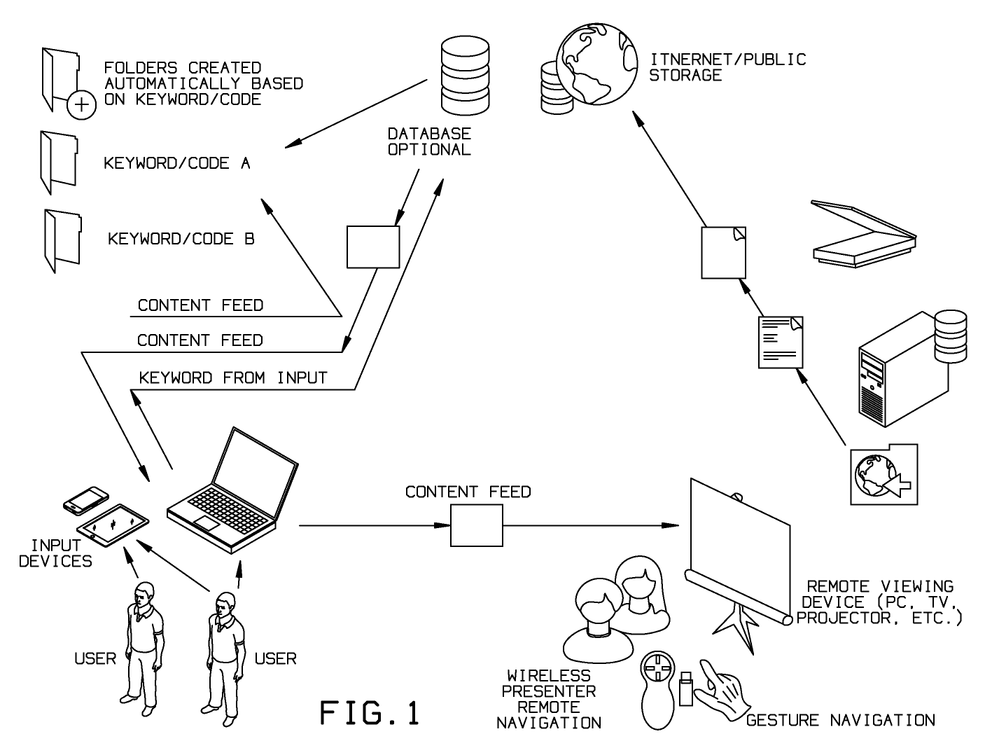

Referring to FIG. 1, and according to an exemplary embodiment of the present invention, content, including static content, streaming content, and interactive content, for example, may be digitized by scanning, image capture, and screen capture, for example. The digital content, which may include content already in digital form, may be grouped and indexed as part of a collection or a content stream. Related or associated content may be grouped using a keyword or taxonomy code, whereby a file system may be leveraged to manage the content by creating a self-indexing mechanism of organizing the content into individual folders that may be named as the keyword or taxonomy code related to the content contained therein.

According to exemplary embodiments of the present invention, the grouped and indexed content may be stored on a storage device that may include a database that may identify or associate locally stored content or from an external source that may be available over a network, for example. According to exemplary embodiments of the present invention, a plurality of keywords may be combined as a single keyword, whereby it may be treated as a single keyword.

The content may be accessed by a computing device that may include a personal computer, a photo frame, a television, a gaming console, a refrigerator, a smart phone, or a tablet device, for example. The computing device may have a user interface that may be configured to receive a keyword or selection input from a user. According to an exemplary embodiment, the user interface may include a keyboard, a touchscreen, or a mouse. The computing device may include a network interface for accessing content that may be externally provided. The computing device may provide a user access to content through a display that may present the content as a collection, a slide show, or a streaming video presentation.

According to some exemplary embodiments, each keyword or taxonomy code based content stream or collection may be retrieved within a different unique context. The same keyword or taxonomy code may be used to retrieve the same and/or different content depending on the context, which may be defined as global, local, or personal, for example. By way of example, the single keyword “news” could provide news content from a global network, local network, or personal storage, allowing seamless content navigation as a slideshow or presentation.

The content may be prepared for user consumption and navigation using a keyboard, mouse/finger gestures, on screen menu controls, wireless presenter/remote control, voice control, or automated slideshow and displayed in rectangular frames on a computing device.

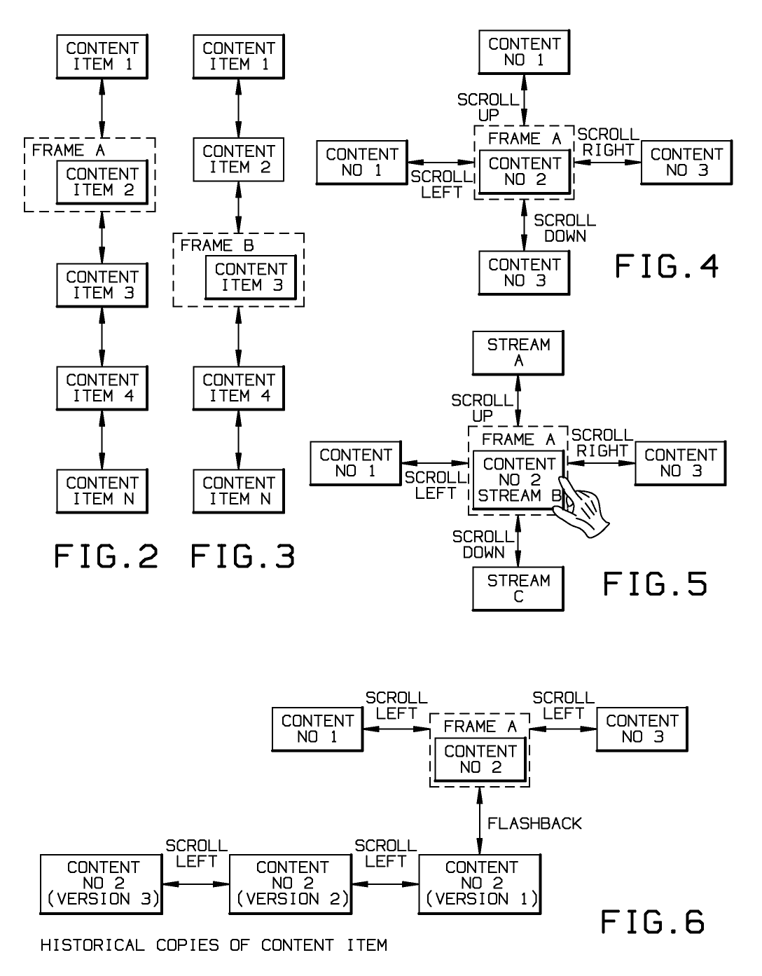

Referring to FIGS. 2 and 3, after retrieving a content stream from keyword/code input, software can display each content stream retrieved in a borderless rectangular frame that adjusts to the size of the active content being displayed on the device. The software can be implemented on a personal computer, mobile device such as a tablet, a smart television, a gaming console, or other smart computing device. Multiple content frames (such as Frame A and Frame B) can be displayed and positioned anywhere on the display device, each containing an independent content stream for user navigation via an input method such as keyboard, mouse, touch, keyboard or the like. A single content stream can contain items from multiple sources, such as a local device, a local network, the internet or the like.

Referring to FIG. 4, after retrieving and displaying content, a frame can optionally provide visual feedback as to which direction (back or forward) the navigation is taking place. As each content item advances, the content slides or scrolls within the frame in a horizontal or vertical direction based on user input or during an automatic slideshow.

Referring now to FIG. 5, after retrieving a content stream from a single keyword/code input, a frame can display content as a two-dimensional multi-stream slideshow allowing navigation across related or unrelated content in a seamless manner. Content movement can be animated via sliding to provide visual feedback as to which direction the navigation is taking place. Vertical navigation switches from Stream A to B to C to infinity, while horizontal navigation advances within the active stream from slide 1 to slide 2 to infinity.

In a PC environment, the frame can use the suffix portion of the application binary executable filename to determine which stream to load. For example, the binary file “FrameDemo2010.exe” would retrieve the “Demo2010” content stream on startup in the appropriate global, local or personal context. However, in other computing device environments where this is not possible or practical, command line parameters can be used to determine the startup content stream.

A standard wireless presenter may be used as an input, where each frame can perform the two-dimensional/multi-stream content navigation using the four inputs from the wireless remote.

Referring to FIG. 6, after retrieving and displaying content, a frame can provide a historical view “flashback” of a particular content item. Once toggling to flashback mode, the historical content displays seamlessly within the existing frame using the same back/forward navigation methods. For example, the flashback mode could be used to view a website snapshot yesterday, two days ago, three days ago, 1 week ago, 1 month ago, and the like.

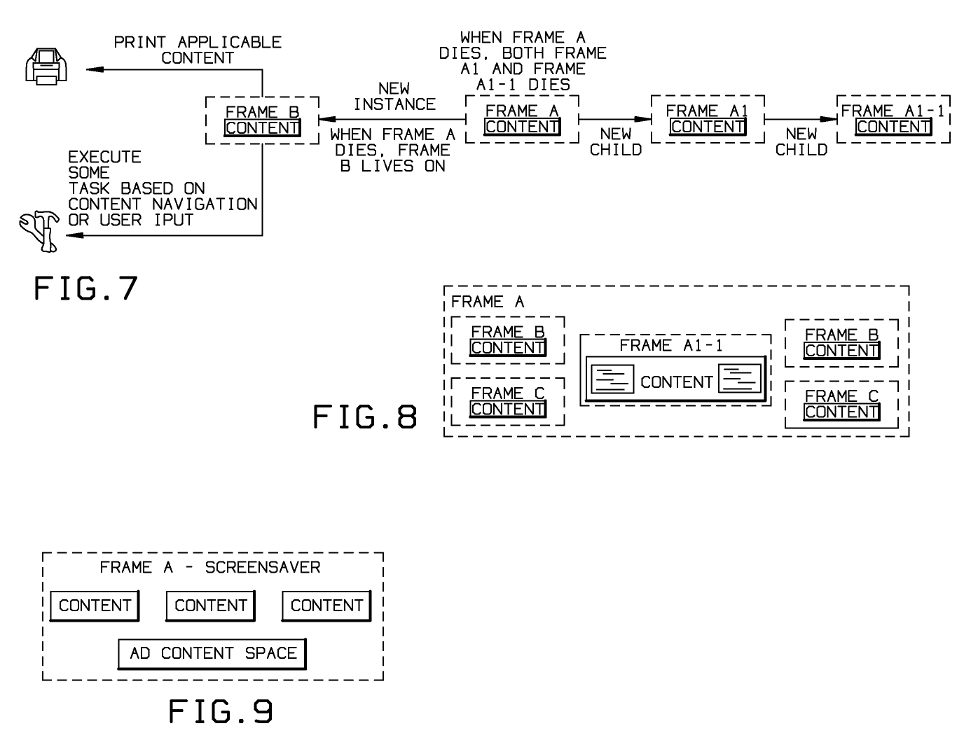

Referring to FIG. 7, after retrieving and displaying content, a frame can perform other tasks, such as printing or emailing the content displayed if applicable, navigating to a URL or executing a specific task based on the content displayed. Frames can also copy content to another frame. Each frame can spawn child frames, and each child frame can further spawn other child frames with the lifetime of each child frame being dependent on the lifetime of the respective parent. Each parent frame or child frame can be duplicated as another separate, non-dependent frame.

Referring to FIGS. 8 and 9, the frames may be used in different scenarios. In FIG. 8, a digital signage is shown. After retrieving and displaying a content stream, each frame can be positioned anywhere on the display device, such as a PC desktop, from a single frame to infinity, as device resources allow. Using any combination of parent frames, and child frames, a complex arrangement can be created to display content from various sources and navigated using methods previously described, as a digital signage/poster display portal.

In FIG. 9, after retrieving and displaying a content stream based on keyword/code, a frame can display content as a screensaver slideshow on a computing device. Content previously collated, digitized and stored, such as website screenshots, aggregated news and/or data comprised of text and images, advertisements, and the like, are displayed as a single, composite image, and optionally allows for content navigation using an input device, such as a standard wireless pointer, voice or motion control, remote messages, or the like. Composite images displayed can be combined from local and/or remote sources into a single playlist, retrieved in a global, local or personal context.

It should be understood, of course, that the foregoing relates to exemplary embodiments of the invention and that modifications may be made without departing from the spirit and scope of the invention as set forth in the following claims.

What is claimed is:

1. A method for retrieving and navigating information using logical keywords or codes, the method comprising:
categorizing digitized content using a keyword taxonomy;
storing the categorized content on a storage device;
providing access to the categorized content in at least one of a global, local or personal context; and
displaying the categorized content as a content slide show within one or more frames.

2. The method of claim 1, further comprising using a wireless presenter remote to toggle through the content slide show within each frame.

3. The method of claim 1, further comprising digitizing content by image capture, scanning and screen capture.

4. The method of claim 1, further comprising grouping related or associated content using the keyword taxonomy or code.

5. The method of claim 1, further comprising using a file system to leverage and manage the stored categorized content by creating a self-indexing mechanism of organizing the content into individual folders.

6. The method of claim 1, wherein the storage device is a database that identifies or associates content.

7. The method of claim 1, further comprising displaying the categorized content as the content slide show where a slide provides visual feedback as to which direction the navigation is taking place within each frame.

8. The method of claim 1, further comprising displaying the categorized content as a content slide show where the frame displays content as a two-dimensional multi-stream slideshow that allows navigation across related or unrelated content in a vertical and horizontal manner.

9. The method of claim 8, further comprising using a wireless presenter remote to allow four-way navigation across multiple content streams.

10. The method of claim 1, further comprising providing a historical flashback mode where historical content is displayed within an existing frame using back and forward navigation.

11. The method of claim 1, further comprising creating at least one of a digital signage, poster display portal, or screensaver using one or more content frames on a device display.

12. A method for retrieving and navigating information using logical keywords or codes, the method comprising:
digitizing content;
categorizing digitized content using a keyword taxonomy;
storing the categorized content on a storage device;
providing access to the categorized content in at least one of a global, local or personal context;
displaying the categorized content as a content slide show; and
using a file system to leverage and manage the stored categorized content by creating a self-indexing mechanism of organizing the content into individual folders.
